(19) United States
(12) Patent Application Publication
(10) Pub. No.: US 2013/0056505 A1
(43) Pub. Date: Mar. 7, 2013

(54) SIZE ADAPTER FOR LIQUID DISPENSING BOTTLES

(71) Applicant: Jonathan H. Cress, Santa Cruz, CA (US)

(72) Inventor: Jonathan H. Cress, Santa Cruz, CA (US)

(21) Appl. No.: 13/604,166

(22) Filed: Sep. 5, 2012

Related U.S. Application Data
(60) Provisional application No. 61/531,961, filed on Sep. 7, 2011.

(51) Int. Cl. B65D 47/06; B23P 6/00

(52) U.S. Cl. 222/568; 29/402.08

(57) ABSTRACT

A liquid dispensing tip comprises both an alternative dispensing tip and an adapter. The alternative tip is sized to be screwed directly onto dispensing bottles having a large diameter connector. The adapter insert is placed inside the alternative dispensing tip when the dispensing bottle has a small diameter connector.

### CROSS-REFERENCE TO RELATED APPLICATION

This application claims the priority of Provisional Application No. 61/531,961 (Attorney Docket No. 33349-708.101), filed Sep. 7, 2011, the entire contents of which is incorporated herein by reference.

### BACKGROUND OF THE INVENTION

1. Field of the invention. The present invention relates generally to devices and methods for dispensing fluids, and more particularly to a size adapter for use in placing an alternative dispensing tip on a conventional fluid dispensing bottle having a screw cap over the dispensing tip.

Fluid dispensing bottles are used for a variety of purposes. Of particular interest to the present invention, liquid droplet dispensers for ophthalmic and other uses typically comprise a squeeze bottle having a dispensing tip. The dispensing tip is typically covered by a threaded cap where external male threads which receive the cap are coaxially disposed about the dispensing tip.

In some instances, it is desirable to connect an alternative dispensing tip over the original tip of the to a fluid dispensing bottle, such as an ophthalmic fluid dispensing bottle. For example, as described in U.S. Pat. No. 7,309,329, having common inventorship with the present application, a diversion tip for attachment to a conventional ophthalmic squeeze bottle comprises a compression ring 104 for use in inserting a tip 108 of the squeeze bottle into a non-threaded receptacle at one end of the diversion tip. The use of such a compression ring, however, has not proven adequate for all purposes, and it would be desirable to provide for a direct threaded connection between the diversion tip and the squeeze bottle. Such direct threaded connection, however, is problematic as squeeze bottles come with threaded cap connections having different diameters, typically falling into two categories, i.e. a large diameter threaded connection and a small diameter threaded connection. Thus, to accommodate all bottles, it would be necessary to provide alternative tips having connectors with two different thread diameters. The need to provide replacement tips of two sizes is not only an inventory problem, it is also difficult for a user to know which size will be needed, making purchasing the diversional tip more difficult.

For these reasons, it would be desirable to provide diversion and other alternative tips for fluid dispensing bottles which address both the inventory and product selection challenges described above. At least some of these objectives will be met by the invention described here below.

2. Description of the background art. U.S. Pat. No. 6,877,626 describes a spill-proof cap intended for replacement over sport drink bottles. The cap includes axially adjacent portions having different thread diameters. U.S. Pat. No. 6,390,315 describes a cap intended for sealing over previously open bottles. The cap has a similar axially spaced thread pattern where small diameter threads are present at the top of the cap base and large diameter threads are present at the bottom of the cap base.

### SUMMARY OF THE INVENTION

The present invention provides systems and methods for attaching alternative dispensing tips onto dispensing bottles having threaded connectors. The alternative dispensing tips of the present invention are provided as part of a system including both the tip and an adapter which allows the tip to be connected to threaded bottle connectors having different diameters.

Systems according to the present invention comprise an alternative dispensing tip and an adapter insert. The replacement dispensing tip has a base with a female threaded connector having a large diameter thread. The large diameter thread is selected to mate with a first size of a dispensing bottle commonly available for use. For example, the large diameter might be in the range from 13 mm to 15 mm, typically being 14 mm. Thus, the alternative dispensing tip can be directly threaded onto such bottles having the large diameter connecting thread.

The adapter insert of the present invention will also have an external male thread sized to mate with the female thread of the alternative dispensing tip and will also have an internal female thread sized to mate or thread onto small diameter threaded connectors conventionally found on fluid dispensing bottles. The small diameter will typically be in the range from 10 mm to 12 mm, usually being about 11 mm. The adapter insert is thus useful for inserting into the female connector of the alternative dispensing tip and allowing the small diameter male connectors on the second type of dispensing bottle to be inserted into the female thread of the insert. In this way, a user can connect the alternative dispensing tip to either of the two conventional sizes of dispensing bottles depending on whether the insert is in place or not.

The alternative dispensing tip and the adapter insert will typically be provided in a sterile package holding both components. Preferably, the alternative dispensing tip and the adapter insert will be disassembled when present in the sterile package. It has been found that it is more intuitive for a user to recognize the purpose of the insert if the components are disassembled initially. The user can then, for example, try placing the alternative dispensing tip on the bottle without the insert to see if it fits. If it does, use of the insert is unnecessary. If the alternative tip base is too large, however, then the user will intuitively recognize that the insert needs to be used. The device packaging, of course, will typically provide instructions as well explaining how the alternative tip can be fit onto bottles having different threaded connector sizes, but often the instructions will not be necessary. Although less preferred, it will also be possible to supply the alternative dispensing tip with the adapter insert threaded into the tip in the sterile package. For the reasons described above, however, such configuration will generally be less preferred.

The adapter insert typically comprises a cylindrical sleeve with external threads formed in an external surface thereof and internal threads formed in an internal surface thereof. The external and internal threads will typically have the same pitch (since the large and small dispenser bottles typically have the same pitch), and will be formed in a corrugated pattern with aligned ridges and grooves of the threads present on each surface of the cylindrical sleeve. The adapter insert will usually further comprise a circumferential flange at a base end thereof. The circumferential flange will be disposed to engage against the dispensing bottle when the adapter insert is threaded onto the dispensing bottle.

The systems of the present invention may be used in methods for placing an alternative tip on the dispensing bottle. The methods comprise first removing a cap or a first dispensing tip from the dispensing bottle to expose connector threads having a first diameter or a second diameter. Using the replacement systems described above, the user then determines whether the tip connector on the dispensing bottle has a small diameter or a large diameter. If the dispensing bottle has small diameter connector, the alternative dispensing tip may be threaded onto the bottle with the insert present to provide the small diameter connecting threads. If, however, the dispensing bottle has a large diameter connector, then the alternative tip is screwed onto the connector with the insert removed from the replacement tip. The insert can then be discarded.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1A and 1B illustrate a system constructed in accordance with the principles of the present invention including an alternative dispensing tip and an adapter insert where the tip and insert are shown disassembled prior to connection to a dispensing bottle in FIG. 1A and where the alternative dispensing tip and adapter insert are shown fully assembled with the dispensing bottle in FIG. 1B.

FIGS. 2A and 2B are similar to FIGS. 1A and 1B, except that the dispensing bottle has a large diameter and the adapter insert is not necessary for attaching the replacement dispensing tip to the dispensing bottle.

FIG. 3 illustrates the system of the present invention including both the replacement dispensing tip and the adapter insert present in sterile packaging in a disassembled configuration.

FIG. 4 similar to FIG. 3 except that the replacement dispensing tip and adapter insert are pre-assembled.

### DETAILED DESCRIPTION OF THE INVENTION

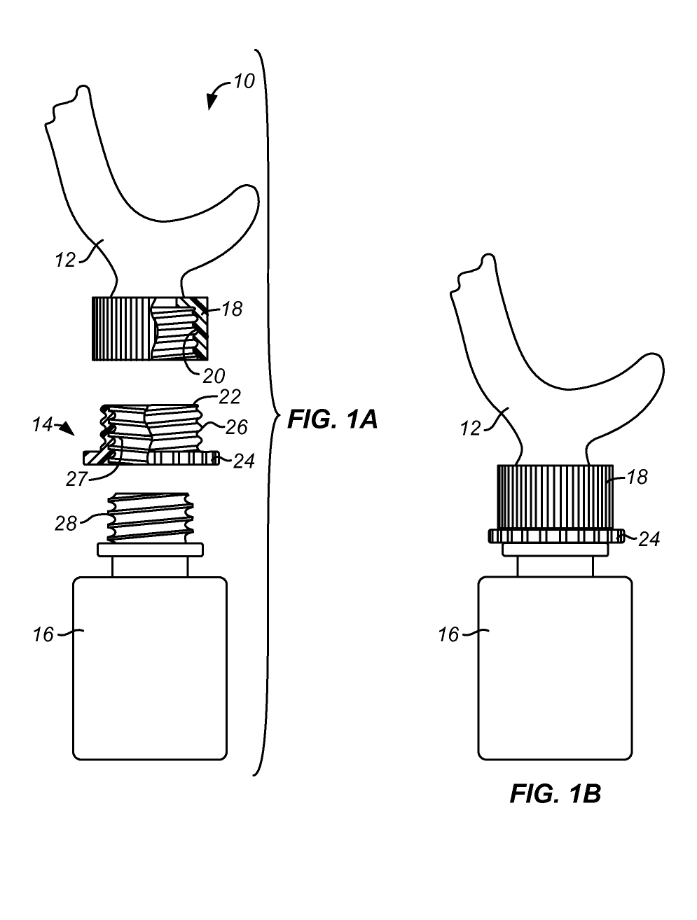

Referring to FIGS. 1A and 1B, alternative liquid dispensing tip system 10 comprises an alternative distal tip 12 and an adapter insert 14. The alternative distal tip and adapter inserted are sized to allow the alternative tip to be placed on a variety of dispensing bottles 16 having male connectors 28 with external threads of different diameters. The alternative distal tip has a base 18 having inner female threads 20 with a first, large diameter. The adapter insert 14, in turn, has a body comprising a cylindrical sleeve 20 with a flange 24 at its lower end. External male threads 26 are formed over an exterior wall of the cylindrical sleeve 22 and internal female threads 27 are formed on an interior wall of the cylindrical sleeve. Usually, the external and internal threads 26 and 27 will have identical pitches, i.e. spacing between adjacent ridges and grooves of the threading, so that the sleeve will, in effect, have a corrugated wall. The use of the corrugated wall structure is particularly advantageous since it allows a relatively thin wall which can accommodate even small changes in diameter between the large and small diameters of the dispensing bottle connectors. Particularly, by placing the male threads 26 of the adapter 14 into the female threads 20 of the base 18 of the alternative distal tip 12, the resulting assembly can then be screwed onto the small diameter male threads 28 of the dispensing bottle 16, as shown in FIG. 1B.

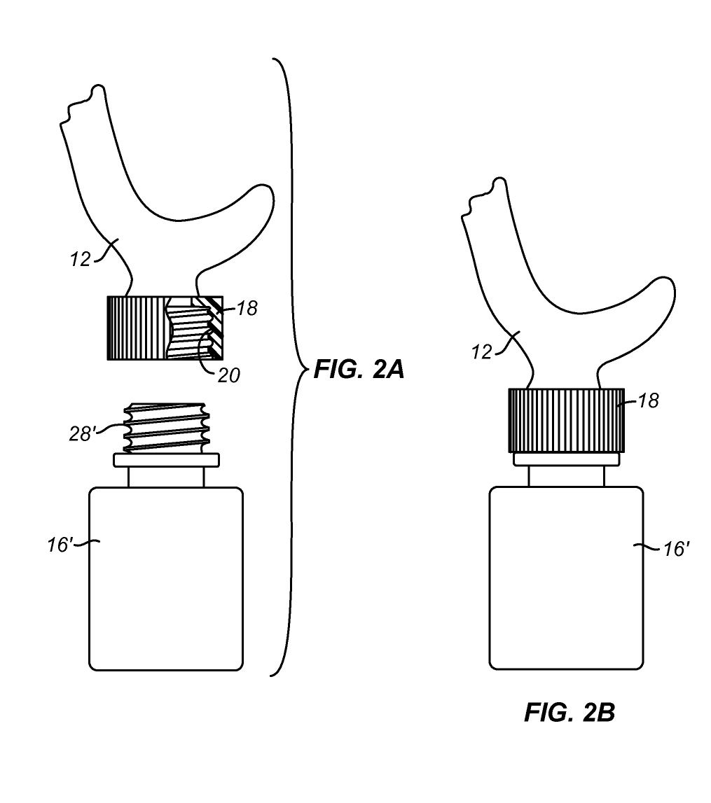

Referring now to FIGS. 2A and 2B, when a dispensing bottle 16′ has a large diameter male external thread pattern, 28′, the adapter 14 is unnecessary, and the base 18 can be screwed directly on to the threads 28′ of bottle 16′, as shown in FIG. 2B. In this way, the single connector 12 can be adapted to fit dispensing bottles having either large diameter connectors or small diameter connectors, thus addressing both the inventory and patient use drawbacks of the prior art.

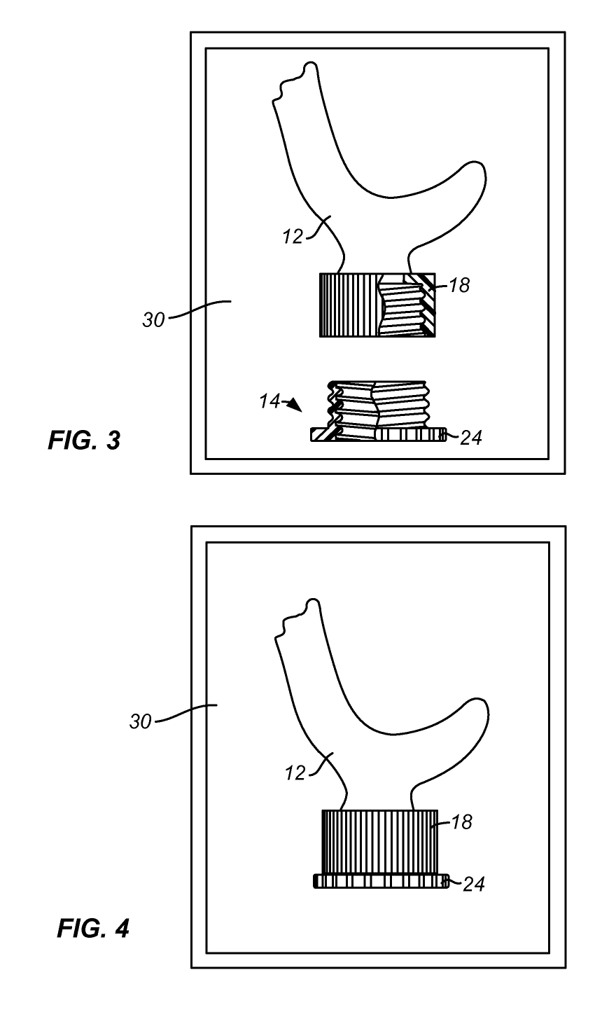

As illustrated in FIG. 3, it will usually be preferred to package the alternative distal tip 12 and the adapter insert 14 in a sterile package 30 in a disassembled configuration. By having them disassembled the user intuitively understands that the insert can be placed into the base 18 into the connector 12 when it is desirable to form a smaller diameter connection. Although less preferred, it is also possible to pre-assemble the alternative distal tip 12 and the connector 14, as shown in FIG. 4, where only the flange 24 of the adapter is visible.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A liquid dispensing tip system for use with a plurality of dispensing bottles having threaded connectors having different diameters, said system comprising:
an alternative dispensing tip having a base with a female threaded connector with a large diameter thread; and
an adapter insert with an external male thread sized to mate with the female threaded connector of the alternative dispensing tip and an internal female thread with a small diameter;
wherein the alternative dispensing tip can be placed on dispensing bottles with a large diameter connector without the insert and can be placed on dispensing bottles with a small diameter connector with the insert in place in the dispensing tip.

2. A system as in claim 1, further comprising a sterile package for holding both the dispensing tip and the adapter.

3. A system as in claim 2, wherein the dispensing tip and the adapter are disassembled within the sterile package.

4. A system as in claim 2, wherein the dispensing tip and the adapter are threaded together within the sterile package.

5. A system as in claim 1, wherein the adapter comprises a cylindrical sleeve with the external threads formed in an extended surface thereof and the internal threads formed in an internal surface thread.

6. A system as in claim 5, wherein the external and internal threads have the same pitch and are formed in the cylindrical sleeve in a corrugated pattern with aligned ridges and grooves on each surface.

7. A system as in claim 6, wherein the adapter further comprises a circumferential flange at a base end which engages against the dispensing bottle when the insert is threaded onto the dispensing bottle.

8. A method for replacing a tip on a dispensing bottle, said method comprising:
removing a cap from the dispensing bottle;
providing a replacement system as in claim 1;
determining whether the tip connector on the dispensing bottle has a small diameter or a large diameter;
if the dispensing bottle connector has a small diameter connector, screwing the alternative tip on to the connector with the insert in place; and
if the dispensing bottle connector has a large diameter connector, screwing the alternative tip onto the connector with the insert removed from the replacement tip.
